(19) United States
(12) Patent Application Publication
(10) Pub. No.: US 2019/0351650 A1
(43) Pub. Date: Nov. 21, 2019

(54) A HONEYCOMB SYSTEM

(71) Applicant: SABIC GLOBAL TECHNOLOGIES B.V., Bergen op Zoom (NL)

(72) Inventors: Sungkyun SOHN, Longmeadow, MA (US); Erich Otto TEUTSCH, Richmond, MA (US); Mohd Aslam KABIR, Pittsfield, MA (US)

(21) Appl. No.: 16/331,305

(22) PCT Filed: Sep. 13, 2017
(86) PCT No.: PCT/US2017/051365

§ 371 Date: Mar. 7, 2019

Related U.S. Application Data
(60) Provisional application No. 62/393,939, filed on Sep. 13, 2016.

(51) Int. Cl. B32B 7/08; B32B 3/12; B32B 29/00; B32B 27/10

(52) U.S. Cl. CPC B32B 7/08; B32B 27/10; B32B 29/002; B32B 3/12

(57) ABSTRACT

A honeycomb system including a honeycomb layer extending in a weft plane, the honeycomb layer defining plural cells; a reinforcing layer extending in a warp plane and at least partially received within the plural cells; and a mechanical interlock adapted to connect the honeycomb layer and reinforcing layer at an intersection thereof.

### FIELD OF THE DISCLOSURE

This disclosure is directed to a honeycomb system. This disclosure is further directed to a honeycomb system that includes a honeycomb layer that defines plural cells with a reinforcing layer running through each cell where adjoining portions of the reinforcing layer and honeycomb layer are interconnected by a mechanical interlock.

### BACKGROUND OF THE DISCLOSURE

An assembly of honeycomb core structures made from thermoplastic papers usually features specialized adhesives requiring long curing times and/or high temperatures. The weight of such adhesives would add significant weight to the article, oftentimes even outweighing the weight of the honeycomb paper itself. It is nearly impossible to further reinforce specific local areas of a traditional honeycomb structure. Also, using different paper compositions for different areas is impractical. There remains a need in the art for structures that provide a reinforced honeycomb structure suitable for an array of uses.

### SUMMARY OF THE DISCLOSURE

According to one aspect, a honeycomb system is provided including a honeycomb layer extending in a weft plane, the honeycomb layer defining plural cells; a reinforcing layer extending in a warp plane and at least partially received within the plural cells; and a mechanical interlock adapted to connect the honeycomb layer and reinforcing layer at an intersection thereof.

According to another aspect, a honeycomb system is provided including a honeycomb layer including plural honey comb strips arranged to jointly define plural cells, the honeycomb strips extending within a weft plane; a reinforcing layer including at least one reinforcing strip extending in a warp plane, the reinforcing layer overlying a portion of the honeycomb layer and extending through at least one of the plural cells, and a mechanical interconnect including a receiver defined within at least one of the honeycomb strips and the reinforcing strip adapted to receive at least a portion of the opposite of the honeycomb strips and reinforcing strip at an intersection thereof to connect the adjacent honeycomb strips together with the reinforcing layer, wherein the receiver receives a sufficient portion of the opposite of the honeycomb strips and reinforcing strip to cause both strips to lie within the same plane.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is a perspective view of a honeycomb system according to the principles of the disclosure.

FIG. 2 is a partially exploded perspective view of a honeycomb system according to the principles of the disclosure.

FIG. 3 is a front view of a honeycomb system according to the principles of the disclosure.

FIG. 4 is a front view similar to FIG. 3 showing an optional adhesive at one or more joints according to the principles of the disclosure.

FIG. 5 is an enlarged view as might be seen in the area indicated in FIG. 1 showing details of one mechanical interlock in a honeycomb system according to the principles of the disclosure.

FIG. 6 is an enlarged view as might be seen in the area indicated in FIG. 1 showing details of one mechanical interlock in a honeycomb system according to the principles of the disclosure.

FIG. 7 is an exploded perspective view of a honeycomb system according to principles of the disclosure showing details of skins attaching to a front and rear surfaces of the honeycomb core according to the principles of the disclosure.

FIG. 8 is a schematic view showing a manufacturing process for making a honeycomb system according to the principles of the disclosure.

FIG. 9 is a diagram of an assembly for finite element analysis of a traditional honeycomb core and a reinforced honeycomb core as described herein.

FIGS. 10A and 10B are simulated diagrams of displacement and stress contour plots for a traditional honeycomb structure, respectively.

FIGS. 11A and 11B are simulated diagrams of displacement and stress contour plots for a reinforced honeycomb structure, respectively, according to various aspects of the present disclosure.

### DETAILED DESCRIPTION OF THE DISCLOSURE

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

The disclosure is directed to a honeycomb system. For example, a honeycomb system including at least one honeycomb layer that defines plural cells, and a reinforcing layer that engages the honeycomb layer and is interconnected to the honeycomb by a mechanical interlock. Honeycomb structure as used herein may refer to a structure of adjoining cavities or cells in a structure. In certain examples, the honeycomb structure may include hexagonal (or regular hexagonal) cells or cavities. According to one example, reinforcing layer may include a layer that runs through each cell.

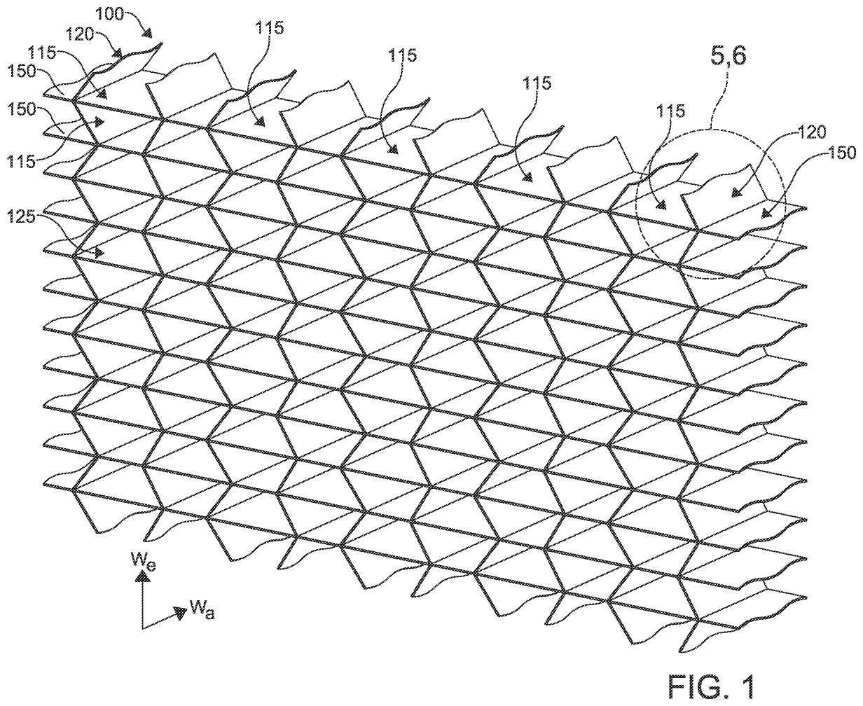

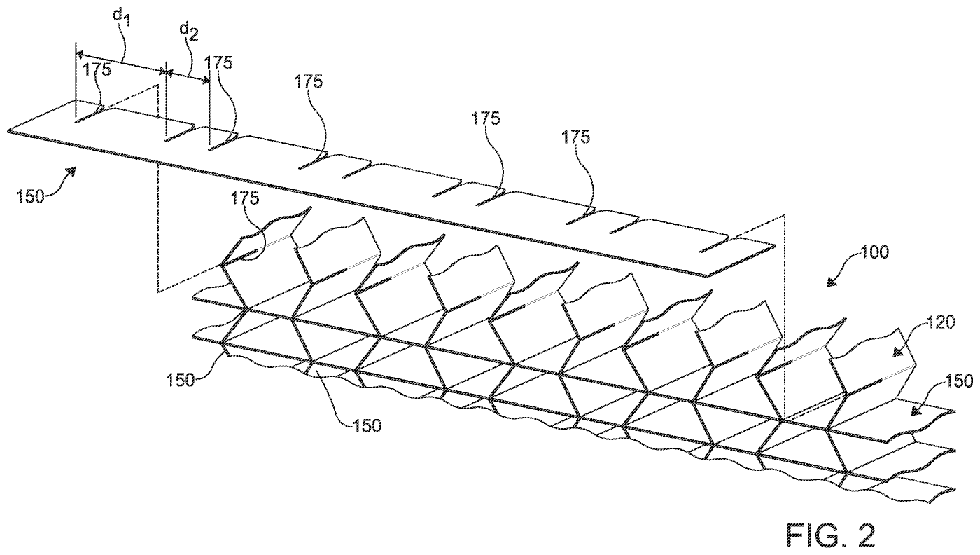

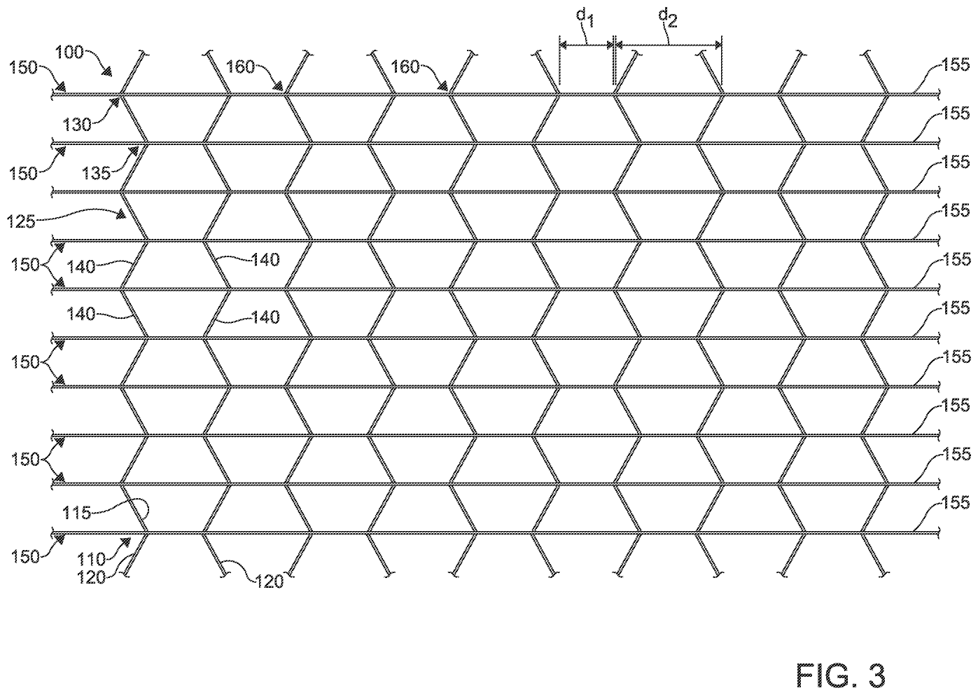

With reference to FIG. 1, a honeycomb system according to the disclosure is generally indicated by the number 100. Honeycomb system 100 generally includes one or more honeycomb layers 110 arranged to form plural cells 115. In the example shown, honeycomb layers 110 include thin strips 120 of material arranged in a common plane referred to herein as the weft direction, weft plane or simply weft and indicated by reference character We. As shown, strips 120 may be corrugated to form a pattern, generally indicated by the number 125. As one example, pattern 125 may define alternating recesses referred to as peak portions 130 and valley portions 135 herein. Adjacent strips 120 may be arranged to align corresponding peak and valley portions to define cells 115. Peak and valley portions 130, 135 may have equal depth such that adjacent strips 120 form the halves of a uniform cell. It will be understood that patterns 125 may be formed with peak and valley portions of unequal or varying depth depending on the desired pattern. The pattern 125 shown is one example, but is not limiting.

In the example shown, peak and valley portions 130, 135 have angled side wall portions 140. As shown, side wall portions 140 may have equal length such that when arranged to form a closed cell 115 with an adjacent strip 120 having the same pattern 125, a regular polygon shaped cell 115 is formed, such as the hexagon shape shown.

A reinforcing layer, generally indicated by the number 150, is interconnected to honeycomb layer 110 to enhance a characteristic of honeycomb layer 110, such as for example, providing greater stiffness, strength, resiliency, or interconnection over at least a portion of honeycomb layer 110. In the example shown, reinforcing layer 150 interconnects adjacent honeycomb strips 120 removing the need for joining adjacent strips with a weld or adhesive.

Reinforcing layer 150 may include reinforcing strips 155 that extend in a direction perpendicular to weft direction We referred to as a warp direction, warp plane or simply warp Wa. In the example shown, reinforcing layer closes or bisects cells 115, depending on its location in the pattern. It will be understood that reinforcing layer may be applied in other directions and still provide the effect of enhancing a characteristic of honeycomb layer 110.

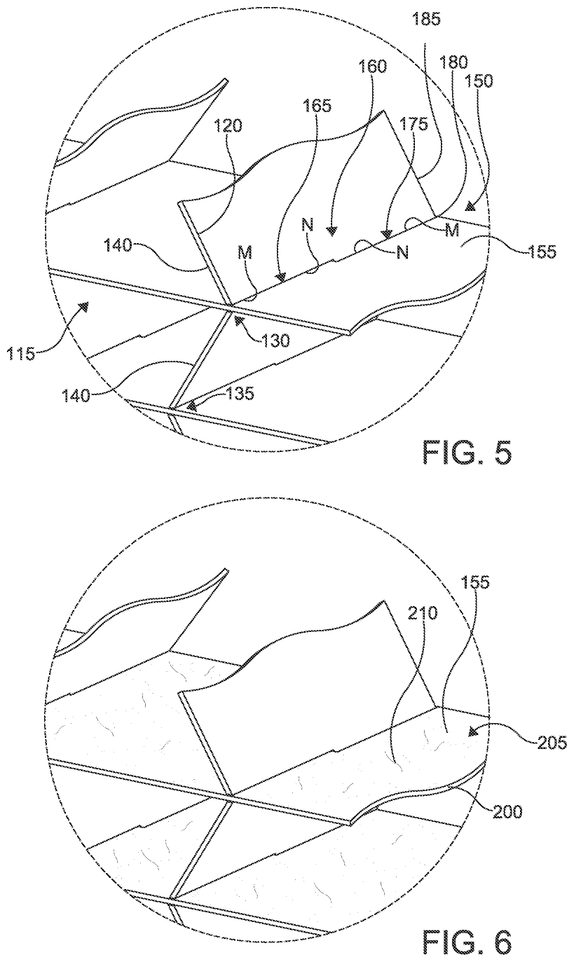

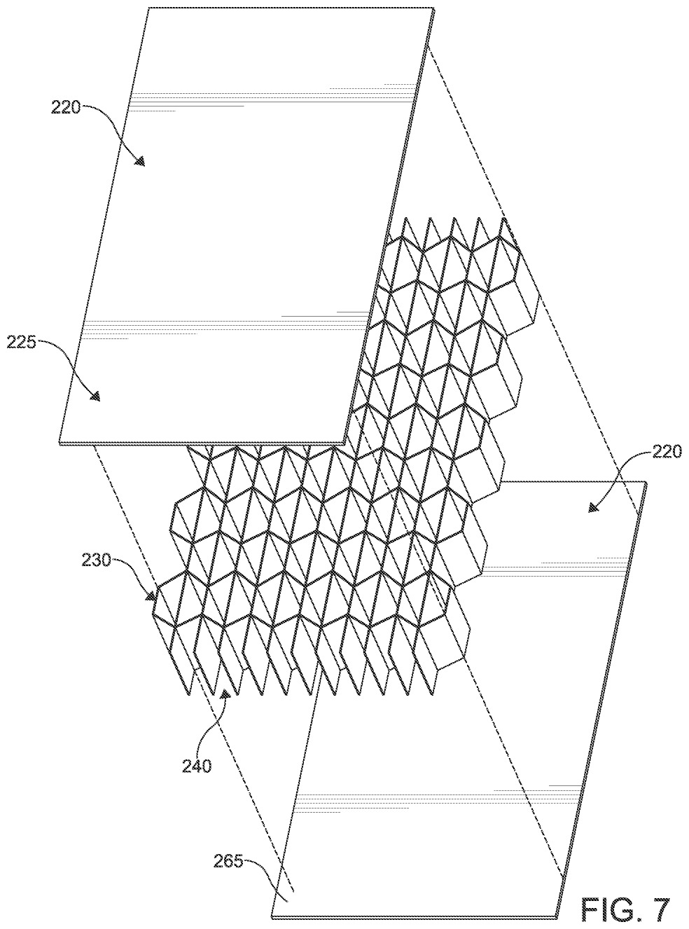

With reference to FIG. 5, honeycomb layer 110 and reinforcing layer 150 are connected by a mechanical interconnect, generally indicated by the number 160. A mechanical interconnect may be an external component such as a fastener attached to join the adjacent layers. Alternatively, as shown, mechanical interconnect 160 may be a structure formed within or on one or more of the layers. For example, mechanical interconnect may include at least one receiver formed in at least one of the honeycomb layer and the reinforcing layer. Receiver may be any opening, recess, notch or other structure that accepts a portion of the opposite layer at the intersection of the honeycomb and reinforcing layers.

In the example, shown receiver includes a slit 165 formed in a portion of one or more of the layers to receive an intersecting portion of an opposite layer. With reference to FIG. 6, honeycomb layer may include a slit 165 that is formed along a fold 170 within honeycomb layer, such as one formed between adjacent wall portions 140,145. Slit 165 extends partially into honeycomb layer 110 in the warp direction to receive a portion of reinforcing layer 150 therein. Reinforcing layer may have a corresponding slit 175 to facilitate interconnecting the reinforcing layer and honeycomb layer. For example, slits 165 and 175 may extend an equal distance within each layer when such layers have an equal thickness to allow the layers to maintain a uniform thickness when the layers are interconnected. In other words, once connected, the reinforcing layer lies within the plane formed by the honeycomb layer such that the edges 180 of the reinforcing layer are flush with the edges 185 of the honeycomb layer or within the planed defined by those edges to facilitate attachment of additional structures to the honeycomb system 100.

According to another example, slits 165,175 may be profiled to facilitate assembly of the honeycomb system 100. For example, a profile, generally indicated by 190, for slit 165 and generally indicated by number 195 for slit 175 have a wider mouth portion M that opens externally and a neck portion N located inward of mouth portion M. Neck portion N may be narrower than mouth portion M as shown. Mouth portion M may taper inward as it extends inward toward neck portion N. Such a configuration facilitates assembly by making it easier to insert an interconnecting strip within the relatively wider mouth portion and the tapered walls of mouth portion M guiding the interconnecting layers into narrower neck portion N to provide uniform and secure engagement of the adjoining layers.

According to another aspect, reinforcing layer may define plural slits 175 that are spaced relative to each other a distance corresponding to the intersection points between reinforcing layer 150 and honeycomb layer 110. In the example shown, a strip in reinforcing layer 150 overlying the hexagonal cells defined by honeycomb layer 110 intersects a first pair of honeycomb strips at two points spaced by a first distance d1 and an adjacent pair of honeycomb strips spaced by the same distance d1. The first and second pairs of strips are spaced relative to each other by a second distance d2, where second distance d2 is greater than first distance d1. This variation in distance is created by the inward angle of the sidewalls of the first and second pairs of strips created by the hexagonal cell pattern within the honeycomb layer. The first pair of slits and second pair of slits in reinforcing layer accordingly are spaced relative to each other by the distance d2. It will be understood that different honeycomb patterns may cause the relative distances between slits to vary from the example shown. For example, if sidewalls having unequal length are used the distance between the intersection of adjacent strips i.e. first distance d1 will vary. Likewise, if a honeycomb pattern is selected to provide strips intersecting with reinforcing layer at regular intervals, such as a triangular corrugation, the first spacing d1 and second spacing d2 may be equal. Other patterns may be selected resulting in additional variation of the distance between adjacent slits in the reinforcing layer.

Connecting honeycomb layer and reinforcing layer through a mechanical interlock formed in the layers themselves allows interconnection of the honeycomb strips without an adhesive or other external fastener. Additionally, in the configuration shown with insertion of the reinforcing layer over the honeycomb layer, the reinforcing layer is not interposed between adjacent strips, and therefore, does not increase the lateral dimension of the honeycomb layer. The reinforcing layer provides this connection and fixes the honeycomb strips relative to each other. The absence of adhesive reduces the weight of honeycomb layer. The addition of reinforcing layer 150 adds weight to the overall structure, but also adds strength to the overall structure resulting in an a stronger overall structure at a similar weight to the non-reinforced honeycomb held together with an adhesive.

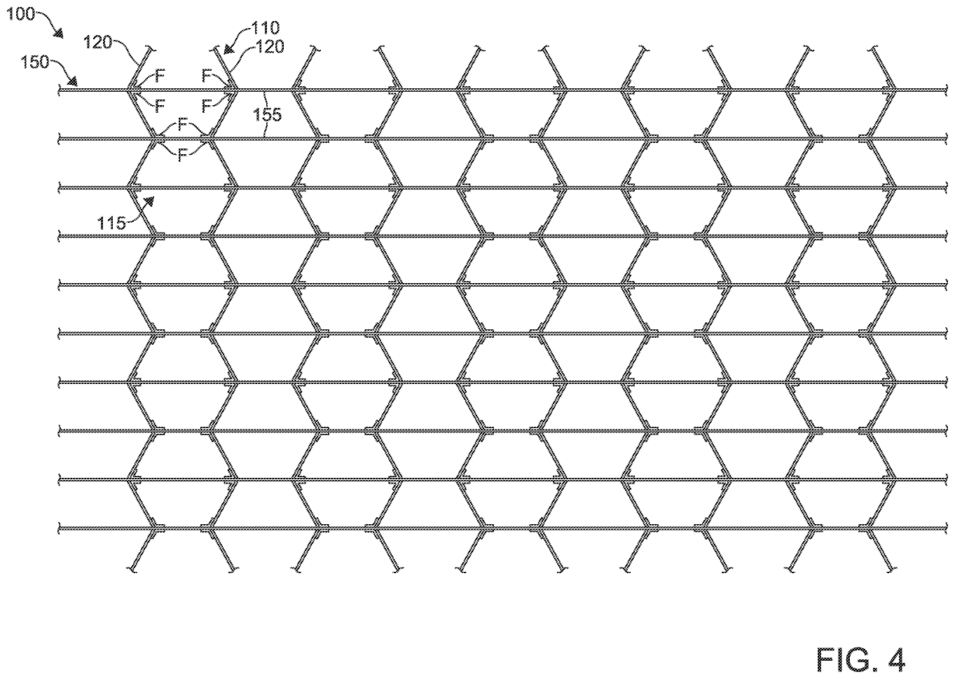

Optionally, an additional fastener F (FIG. 4) may be used to supplement the mechanical interlock between the honeycomb and reinforcing layers. Additional fastener may include a mechanical fastener, a weld, an adhesive, or a coating. Separately, depending on the materials used to form the honeycomb and reinforcing layers, heat may be applied to cure or partially melt the materials forming those layers to bond them to each other or otherwise set the a honeycomb system 100.

With reference to FIG. 6, as a further option, reinforcing layer may provide enhanced characteristics by adding a layer to honeycomb system 10C having different material properties. Reinforcing layer 150 may be of the same material as honeycomb layer 110, or as shown in FIG. 6, reinforcing layer 150 may have different material properties. For example, reinforcing layer 150 may be constructed of a different material than honeycomb layer 110. In the example shown, honeycomb layer 110 is constructed of a paper material and reinforcing layer is constructed of paper base material 200 with a reinforcement, generally indicated by the number 205. Reinforcement 205 may include reinforcing material of any known type including reinforcing particles, fibers or other suitable configurations that are attached, interwoven or otherwise incorporated with a base material 200. Reinforcement 205 may also be the same or similar material with different properties resulting from mechanical enhancement, such as, providing higher densities of fibers, particles, or other components making up the base material, or applying treatments to the base material, such as chemical, light, heat, or other treatments that alter the property of the material. These may be applied during formation of the reinforcement or applied after a base material is formed to create reinforcement 205.

Reinforcement 205 may be provided globally to the entire reinforcement layer or locally to tailor the material properties of reinforcement layer in designated areas. As a further alternative, global and local reinforcement may be combined. For example, as shown in FIG. 6, reinforcement layer includes a global reinforcement depicted by particles spread throughout the reinforcing layer and local reinforcement provided by reinforcing fibers 210 in the depicted example. The reinforcing fibers 210 are just one example of a local reinforcement. It will be understood that local reinforcement may be accomplished by providing more fibers in one region than others i.e. increasing fiber density, providing thicker fibers, or stronger fibers. In addition non-fiber reinforcement may be provided including reinforcing particles, chemical, light, heat or other treatments that change or supplement the material, and combinations thereof.

Reinforcement layer may also include at least one type of continuous fiber material designed to help provide strength. Fibers suitable for use in the disclosure include glass fibers, carbon fibers, graphite fibers, synthetic organic fibers, particularly high modulus organic fibers such as para- and meta-aramid fibers, nylon fibers, polyester fibers, or any of the thermoplastic resins mentioned above that are suitable for use as fibers, natural fibers such as hemp, sisal, jute, flax, coir, kenaf and cellulosic fibers, mineral fibers such as basalt, mineral wool (e.g., rock or slag wool), Wollastonite, alumina silica, and the like, or mixtures thereof, metal fibers, metalized natural and/or synthetic fibers, ceramic fibers, or mixtures thereof.

Base material 200 may be any suitable material used in honeycomb structures including but not limited to pulp products, such as paper, card board, wood, cork, and the like; plastics, metals, and combinations thereof. In the example shown, a paper base material 200 is used and provided with a reinforcement 205.

In the example shown, reinforcement 205 includes at least one polymer reinforcing fiber 210 including but not limited to thermoplastic or thermoset resins are bonded to base material layer 200 to form the reinforcing strip. For example, a paper base material may be provided with an aramid (aromatic polyamide) based paper reinforced with a thermosetting resin. Alternatively, polyetherimide resin may be incorporated. Other suitable polymer materials include but are not limited to polythene (PE), polypropylene (PP), polyvinyl chloride (PVC), polytyrene (PS), nylons, and polytetrofluoro ethylene (PTFE or Teflon™). Examples of thermoset plastics include phenolic resins, amino resins, polyester resins, silicon resins, epoxy resins, and polyurethanes. Further non-limiting examples of suitable thermoplastic resins include polyacetal, polyacrylic, styrene acrylonitrile, acrylonitrile-butadiene-styrene (ABS), polycarbonate, polystyrene, polyethylene, polyphenylene ether, polypropylene, polyethylene terephthalate, polybutylene terephthalate, Nylons (Nylon-6, Nylon-6/6, Nylon-6/10, Nylon-6/12, Nylon-11 or Nylon-12, for example), polyamideimide, polyarylate, polyurethane, ethylene propylene diene rubber (EPR), ethylene propylene diene monomer (EPDM), polyarylsulfone, polyethersulfone, polyphenylene sulfide, polyvinyl chloride, polysulfone, polyetherimide, polytetrafluoroethylene, fluorinated ethylene propylene, perfluoroalkoxyethylene, polychlorotrifluoroethylene, polyvinylidene fluoride, polyvinyl fluoride, polyetherketone, polyether ether ketone (PEEK), liquid crystal polymers and mixtures comprising any one of the foregoing thermoplastics. The thermoplastic resin may also be propriety resin materials, such as Noryl GTX™, which is a blend of polyamide and modified polyphenylene ether, or Thermocomp™ RC008™, which is a Nylon 66 resin. It is anticipated that any thermoplastic resin may be used in the present disclosure that is capable of being sufficiently softened by heat to permit fusing and/or molding without being chemically or thermally decomposed.

To further tailor the properties or honeycomb system 100, a second fiber reinforced material may be used to form honeycomb layer. The second fiber-reinforced polymer material may be selected from the non-exhaustive list of the first fiber-reinforced polymer material described herein. The second thermoplastic resin may be selected from the non-exhaustive list of first thermoplastic resins described above. Although the second thermoplastic resin may be different than the first thermoplastic resin, it may be desirable that the first thermoplastic resin and the second thermoplastic resin share a common polymeric material. The specific materials mentioned above are merely described for exemplary purposes.

The honeycomb system shown in the drawings is not limited to the dimensions and proportions shown. It will be understood that length, width, and depth of the enhanced honeycomb may be varied from the one shown by varying the dimensions of the honeycomb and reinforcing layers to provide a honeycomb system 100 of suitable size for a given application.

According to another aspect, honeycomb system 100 may further include one or more skins 220 attached to a surface of honeycomb system 100. In the example shown, a first skin 225 is oriented parallel to the weft direction We and attached to a first side 230 of honeycomb system 100. A second skin 235 may also be oriented parallel to weft direction We and attached to a second side 240 of honeycomb system 100 opposite first skin 225 to sandwich honeycomb system 100 there between to form a sandwich structure, generally indicated at 240, with an enhanced honeycomb core 245. Additional skins may be attached to the edges of core 245.

Aspects of the disclosure may utilize an injection molding barrel/screw (not shown). An injection molding barrel/screw may include a hopper. Pellets of thermoplastic material and/or fiber reinforced thermoplastics may be supplied by the hopper to the injection molding barrel/screw. In some aspects, a gas (blowing agent) from a gas source may be introduced. The injection molding barrel/screw may include a cylinder maintaining a screw. The screw may further include a motor or the like for moving the screw. Additionally, the injection molding barrel/screw may include at least one heater. A nozzle and/or an associated shutoff valve may include at least one heater to maintain a temperature of the pellets and/or increase the temperature of the pellets to melt the same. Other constructions associated with the injection molding barrel/screw are contemplated as well.

The first fiber-reinforced polymer material may include a laminate made from at least one of a uni-directional tape, a prepack roll, a two-dimensional fabric, a three-dimensional fabric, commingled fibers, a film, a woven fabric, and a non-woven fabric. The first fiber-reinforced polymer material may be made through a melt process, from a chemical solution, from a powder, by film impregnation, or the like. The woven and non-woven fabric materials may be made from the first thermoplastic resin.

The honeycomb layer of the disclosed honeycomb system may have a particular weight. That is, the paper from which the honeycomb layer is formed may have a certain weight. For example, the honeycomb layer may have a weight of from about 40 grams per square meter (gsm) to about 200 gsm. It is noted that the paper may be further reinforced with solid and/or liquid additives, either before or after the honeycomb construction, in order to increase the stiffness. In a specific example, the honeycomb system may have certain cell dimensions. For example, the honeycomb system may a cell wall thickness of 0.2 millimeters (mm). Cell side lengths may be about 4 mm and sidewall to sidewall lengths may be about 7 mm.

The reinforcing layer of the disclosed honeycomb system may have a particular thickness. The reinforcing layer may have a thickness of about 50 micrometers (microns, μm) to about 500 microns. In some examples, the honeycomb layer and the reinforcing layer have a uniform weight and uniform thickness.

The reinforced honeycomb structure described herein may provide certain advantages when compared to a conventional honeycomb structure. The disclosed honeycomb system may provide greater stiffness than a traditional honeycomb structure having the same cell dimensions and formed from a material of the same weight. Stiffness may depend upon a number of parameters including, but not limited to, the material and the dimensions (thickness, length, etc.) of the honeycomb structure; the composition and weight (inorganic fiber orientation, etc.) of the material forming the structure. For example, the honeycomb system may exhibit a stiffness of about 20% greater than the stiffness observed for a traditional honeycomb structure, wherein the honeycomb system and the traditional honeycomb structure have the same cell dimension and are formed from a paper having a weight of 60 gsm, when the honeycomb system and the traditional honeycomb structure are tested according to a finite element analysis using a reaction force for a displacement magnitude of 3 mm. In further examples, the honeycomb system may exhibit a maximum stress of at least 3000 megapascals (MPa) when tested according to a finite element analysis using a reaction force for a displacement magnitude of 3 mm wherein the honeycomb layer and reinforcement layer of the honeycomb system have a weight of 60 gsm.

In yet further aspects, while the reinforced honeycomb structure may ostensibly weigh more than a traditional honeycomb structure having the same cell dimensions and formed from the same material (or a material having the same weight), the disclosed reinforced honeycomb structure may indeed weigh less than its traditional counterpart if the mass of adhesive used to form a traditional honeycomb is considered. The disclosed honeycomb system may not require adhesive to connect the honeycomb and reinforcing layers. Accordingly, the honeycomb system of the present disclosure may provide improved stiffness and less weight than its conventional honeycomb counterpart.

Articles, generally indicated at 250, produced according to the disclosure include, for example, computer and business machine housings, home appliances, trays, plates, handles, helmets, vehicle components such as aircraft structural members, walls, floors, wings, instrument panels, cup holders, glove boxes, interior coverings and the like. In various further aspects, formed articles include, but are not limited to, food service items, medical devices, animal cages, electrical connectors, enclosures for electrical equipment, electric motor parts, power distribution equipment, communication equipment, computers and the like, including devices that have molded in snap fit connectors. In a further aspect, articles of the present disclosure include exterior body panels and parts for outdoor vehicles and devices including automobiles, protected graphics such as signs, outdoor enclosures such as telecommunication and electrical connection boxes, and construction applications such as roof sections, wall panels and glazing. Multilayer articles made of the disclosed polycarbonates particularly include articles which will be exposed to ultra violet (UV) light, whether natural or artificial, during their lifetimes, and most particularly outdoor articles; i.e., those intended for outdoor use. Suitable articles are exemplified by enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; facsimile machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated articles; and like applications.

In one aspect, the parts can include articles including the disclosed glass fiber filled polymeric materials. In a further aspect, the article including the disclosed glass fiber filled polymeric materials can be used in automotive applications. In a yet further aspect, the article includes the disclosed glass fiber filled polymeric materials can be selected from instrument panels, overhead consoles, interior trim, center consoles, panels, quarter panels, rocker panels, trim, fenders, doors, deck lids, trunk lids, hoods, bonnets, roofs, bumpers, fascia, grilles, minor housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards. In an even further aspect, the article including the disclosed glass fiber filled polymeric materials can be selected from mobile device exteriors, mobile device covers, enclosures for electrical and electronic assemblies, protective headgear, buffer edging for furniture and joinery panels, luggage and protective carrying cases, small kitchen appliances, and toys.

In one aspect, the parts can include electrical or electronic devices including the disclosed glass fiber filled polymeric materials. In a further aspect, the electrical or electronic device can be a cellphone, an MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

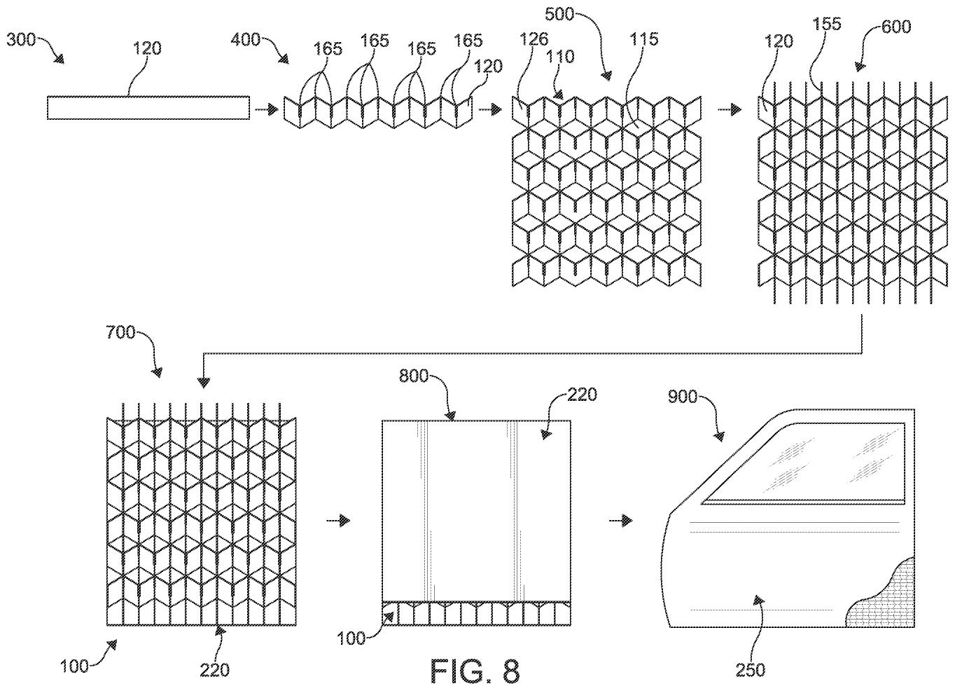

With reference to FIG. 8, a method of forming a honeycomb system 100 is shown. The example is shown schematically and is not limiting as other honeycomb formation techniques may be applied. In the example shown, at a step 300, a strip 120 is provided. At a step 400, the strip 120 is processed to corrugate or otherwise shape the strip for use in defining cells within the honeycomb layer. In the example shown, strip 120 is processed to form plural folds 170 to define angled sidewalls 140 there between. In accordance with one embodiment described to both, each fold 170 may be provided with a receiver 160 such as a slit 165 that extends at least partially into the strip. At a step 500, plural strips formed in accordance with step 400 are arranged adjacent to each other to form the honeycomb layer 110. At step 600, a reinforcing layer 150 extending in a work direction is applied to honeycomb layer 110. The mechanical interlock 160 between honeycomb layer 110 and reinforcing layer 150 interconnects the adjacent strips 120 and 155 to form an enhanced honeycomb system 110 without adhesive. At step 700, a skin 220 may be applied to a first side of honeycomb and at step 800, a skin 220 may be applied to a second side of the reinforced honeycomb to form a honeycomb sandwich structure. The honeycomb system may be incorporated into an article 250, as schematically depicted in step 900.

### EXAMPLES

According to the examples provided herein, a finite element analysis (FEA) was used to numerically test a honeycomb having a reinforced structure comprising single wall cells. A finite element analysis of a traditional honeycomb having single and double wall cells was also performed for purposes of comparison. The software used for performing the finite element analysis was Abaqus™ software, but other programs may be suitable.

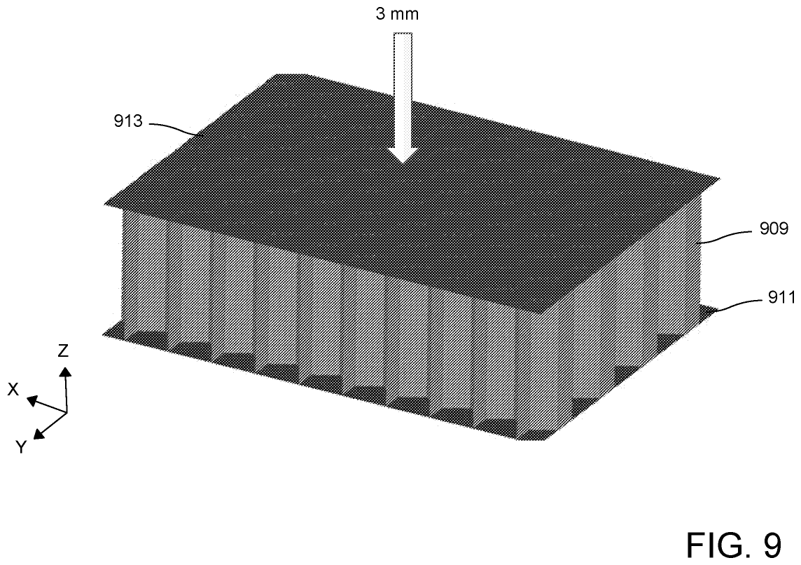

Numerical compression experiments, i.e., the FEA, were performed on honeycomb core dimensions of 70 mm length by 50 mm height by 20 mm height. There were ten honeycomb cells or cavities in the X direction and 7 honeycomb cells or cavities in the Y direction. FIG. 9 presents a diagram of the set up for the FEA showing a honeycomb core structure 909 for testing between a fixed base plate 911 and a rigid plate applicator 913. A displacement of 3 mm was applied to the honeycomb core 909. FEA models with the same dimensions were created for both traditional honeycomb and the reinforced honeycomb described herein. Reaction forces and stresses were obtained. Honeycomb core stiffness was derived from reaction forces as well. Stiffness results for traditional and the disclosed reinforced honeycomb configurations were compared.

The traditional HC structure was comprised of single and double wall cells, reflecting actual construction geometry where corrugated layers are bonded together to form cells. the reinforced HC structure was comprised of single wall cells only. In the analysis, the single wall reinforced honeycomb included single wall cells with a cell wall thickness of about 0.2 mm. The mixed double and single wall honeycomb included cells having single walls having a wall thickness of about 0.2 mm and double walls having a thickness of about 0.4 mm. The traditional honeycomb and the reinforced honeycomb structures for testing had the same cell dimensions. For both honeycomb structure types, the cell side lengths were about 4 mm and sidewall to sidewall lengths were about 7 mm. Schematic drawings of the single wall honeycomb and single/double wall honeycomb used in the experiment are depicted below.

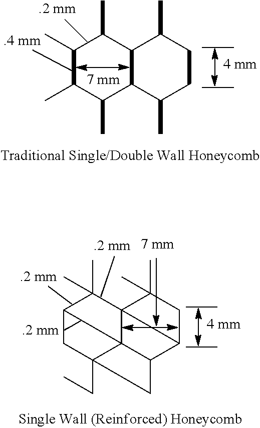

Material properties of the paper that formed the both the traditional and reinforced honeycomb structures in the simulations were based on a formulated 60 gram per square meter (gsm) paper, produced on a wet-laid process. The paper comprised of 15% carbon fiber, 10-40% aramid fiber, 30-60% poly(ether imide) fiber, and 5-20% poly(vinyl alcohol) fiber.

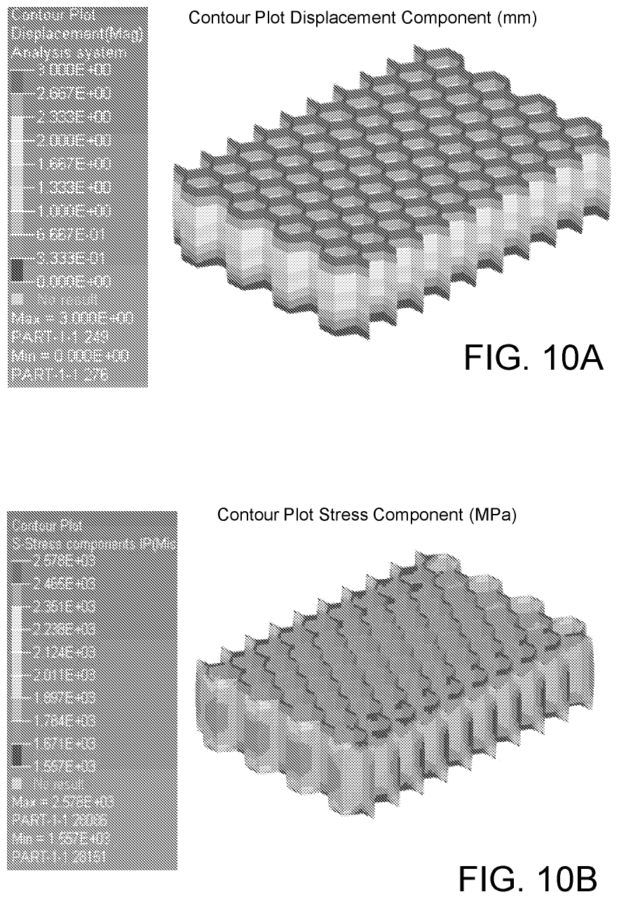

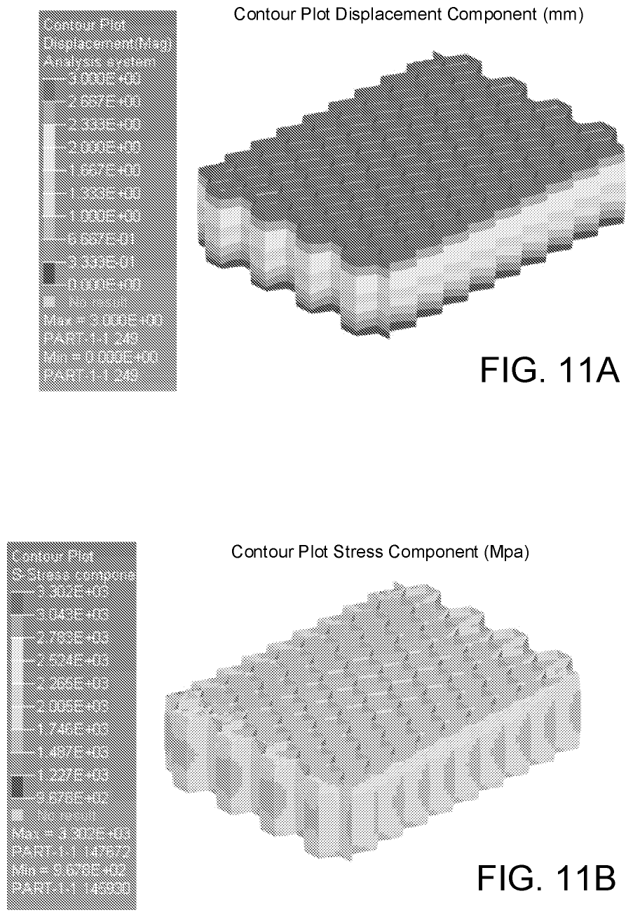

As described above, finite element analysis was used to measure stiffness in response to a normal force applied to the top of the traditional and reinforced honeycombs to provide the displacement and stress contour plots of FIGS. 10A and 10B (traditional) and the stress contour plots of FIGS. 11A and 11B (reinforced). FIGS. 10A and 10B present simulated displacement (displacement magnitude) and stress contour plots for the traditional honeycomb structures, respectively. FIGS. 11A and 11B present simulated displacement (magnitude) and stress contour plots for the reinforced honeycomb structures, respectively.

The displacement magnitude of 3 mm is shown for the traditional honeycomb structure (FIG. 10A and the reinforced honeycomb structure (11A). Stiffness of the honeycomb structures was evaluated in relation to the stress component (in megapascals, MPa) observed from the applied reaction force that provided the displacement of 3 mm. The stress component for the traditional honeycomb structure had a maximum of 2.578×10³ MPa, which is supported by the appearance of a darker gradient (about 1.671×10³ MPa) throughout the upper area of the simulated contour plot where the displacement reaction force is applied. When compared to the reinforced honeycomb structure which exhibited a maximum stress of about 3.302×10³ MPa, corresponding to a lighter gradient in the contour plot for the stress component contour plot where the displacement reaction force is applied. Table 1 summarizes the maximum values and the values for stress apparent where the load is applied.

TABLE 1
Simulated stress component values for traditional
and reinforced HC structures.

| | Stress_{Maximum} | Stress_{Observed at Displacement} |
|---|---|---|
| | (MPa) | (MPa) |
| Traditional HC | 2578 | 1671 |
| Reinforced HC | 3302 | 2005 |
| Difference | +28% | +20% |

Higher values for the stress component correspond to greater stiffness. The simulated results indicate that the reinforced honeycomb according to the examples displays superior stiffness, about 20% higher than that of the traditional single/double wall structure. Thus, the reinforced honeycomb component exhibited stiffness from about 12% to 25% greater, more specifically, about 18% greater than the stiffness of a traditional honeycomb structure having the same sell dimension.

It is also noted that the reinforced honeycomb in the experiment weighed about 23% more than the traditional honeycomb. This weight however does not account for the adhesive needed to form the traditional honeycomb structure. It is expected that the added adhesive weight would at least double the weight of the traditional honeycomb. Such a weight increase suggests that the reinforced honeycomb according to the examples disclosed herein would provide a significant weight savings while also improving stiffness.

### EXAMPLES

### Example 1A

A honeycomb system comprising a honeycomb layer extending in a weft plane, the honeycomb layer defining plural cells; a reinforcing layer extending in a warp plane and at least partially received within the plural cells; and a mechanical interlock adapted to connect the honeycomb layer and reinforcing layer at an intersection thereof.

### Example 1B

A honeycomb system consisting essentially of a honeycomb layer extending in a weft plane, the honeycomb layer defining plural cells; a reinforcing layer extending in a warp plane and at least partially received within the plural cells; and a mechanical interlock adapted to connect the honeycomb layer and reinforcing layer at an intersection thereof.

### Example 1C

A honeycomb system consisting of a honeycomb layer extending in a weft plane, the honeycomb layer defining plural cells; a reinforcing layer extending in a warp plane and at least partially received within the plural cells; and a mechanical interlock adapted to connect the honeycomb layer and reinforcing layer at an intersection thereof.

### Example 2

The honeycomb system of any of examples 1A-1C, wherein the mechanical interlock includes a receiver formed within at least one of the honeycomb layer and the reinforcing layer, wherein a portion of the opposite layer is accepted within the receiver at an intersection of the honeycomb layer and reinforcing layer.

### Example 3

The honeycomb system of example 2, wherein the receiver includes a slit extending partially into the at least one of the honeycomb layer and the reinforcing layer.

### Example 4

The honeycomb system of examples 2 or 3, wherein the receiver includes a mouth portion and a neck portion, wherein the mouth portion opens outwardly of the at least one of the honeycomb layer and reinforcing layer, and wherein the mouth portion is wider than the neck portion.

### Example 5

The honeycomb system of example 4, wherein the mouth portion tapers inward as it extends inward toward neck portion.

### Example 6

The honeycomb system of examples 1-5, wherein the honeycomb layer includes a honeycomb strip, the honeycomb strip including plural sidewall portion portions, each sidewall portion extending at an angle to form a fold, wherein the mechanical interconnect is formed in said fold.

### Example 7

The honeycomb system of examples 1-5, wherein the reinforcing layer includes a base material and a reinforcing material.

### Example 8

The honeycomb system of example 7, wherein the reinforcing material is at least one of a thermoplastic and thermoset material incorporated into the reinforcing layer.

### Example 9

The honeycomb system of Example 8, wherein the reinforcing material includes a local reinforcement applied to a limited area of base material.

### Example 10

The honeycomb system of Example 9, wherein the local reinforcement is a reinforcing fiber.

### Example 11

The honeycomb system of Example 8, wherein the reinforcing material includes a global reinforcement and a local reinforcement.

### Example 12

The honeycomb system of Example 8, wherein the base material is an aramid-based paper and the reinforcing material is a thermosetting resin.

### Example 13

The honeycomb system of Examples 1-7, further comprising at least one skin attached to a surface of the honeycomb layer.

### Example 14

The honeycomb system of Examples 1-13, wherein the honeycomb layer and the reinforcing layer have a uniform thickness.

### Example 15

The honeycomb system of Examples 1-13, wherein the honeycomb layer and the reinforcing layer have a thickness of about 2 mm.

### Example 16

The honeycomb system of any one of Examples 1-13, wherein one or both of the honeycomb layer and the reinforcing layer has a weight from about 20 gsm to about 400 gsm.

### Example 17

The honeycomb system of any one of Examples 1-13, wherein the reinforcing layer has a thickness from about 50 microns to about 500 microns.

### Example 18

The honeycomb system of any one of examples 1-17, wherein the honeycomb layer has a thickness of about 2 mm.

### Example 19

The honeycomb system of any one of Examples 1-18, wherein the honeycomb system exhibits a maximum stress of at least 3000 MPa when tested according to a finite element analysis using a reaction force for a displacement magnitude of 3 mm wherein the honeycomb layer and reinforcement layer of the honeycomb system have a weight of 60 gsm.

### Example 20

The honeycomb system of Examples 1-18, wherein the honeycomb system exhibits a stiffness of from about 12% to about 25%, or 12% to 25%, greater than the stiffness observed for a traditional honeycomb structure, wherein the honeycomb system and the traditional honeycomb structure have the same cell dimension and are formed from a paper having a weight of 60 gsm, when the honeycomb system and the traditional honeycomb structure are tested according to a finite element analysis using a reaction force for a displacement magnitude of 3 mm.

### Example 21

The honeycomb system of Examples 1-18, wherein the honeycomb system exhibits a stiffness of 20% or about 20% greater than the stiffness observed for a traditional honeycomb structure, wherein the honeycomb system and the traditional honeycomb structure have the same cell dimension and are formed from a paper having a weight of 60 gsm, when the honeycomb system and the traditional honeycomb structure are tested according to a finite element analysis using a reaction force for a displacement magnitude of 3 mm.

### Example 22

The honeycomb system of Examples 1-13, wherein the honeycomb layer and the reinforcing layer are connected without an adhesive.

### Example 23

The honeycomb system of Examples 1-13, wherein the honeycomb system is free of or substantially free of adhesive or weld used to join the honeycomb layer and the reinforcing layer.

### Example 24A

A honeycomb system comprising a honeycomb layer including plural honey comb strips arranged to jointly define plural cells, the honeycomb strips extending within a weft plane; a reinforcing layer including at least one reinforcing strip extending in a warp plane, the reinforcing layer overlying a portion of the honeycomb layer and extending through at least one of the plural cells, and a mechanical interconnect including a receiver defined within at least one of the honeycomb strips and the reinforcing strip adapted to receive at least a portion of the opposite of the honeycomb strips and reinforcing strip at an intersection thereof to connect the adjacent honeycomb strips together with the reinforcing layer, wherein the receiver receives a sufficient portion of the opposite of the honeycomb strips and reinforcing strip to cause both strips to lie within the same plane.

### Example 24B

A honeycomb system consisting essentially of a honeycomb layer including plural honey comb strips arranged to jointly define plural cells, the honeycomb strips extending within a weft plane; a reinforcing layer including at least one reinforcing strip extending in a warp plane, the reinforcing layer overlying a portion of the honeycomb layer and extending through at least one of the plural cells, and a mechanical interconnect including a receiver defined within at least one of the honeycomb strips and the reinforcing strip adapted to receive at least a portion of the opposite of the honeycomb strips and reinforcing strip at an intersection thereof to connect the adjacent honeycomb strips together with the reinforcing layer, wherein the receiver receives a sufficient portion of the opposite of the honeycomb strips and reinforcing strip to cause both strips to lie within the same plane.

### Example 24C

A honeycomb system consisting of a honeycomb layer including plural honey comb strips arranged to jointly define plural cells, the honeycomb strips extending within a weft plane; a reinforcing layer including at least one reinforcing strip extending in a warp plane, the reinforcing layer overlying a portion of the honeycomb layer and extending through at least one of the plural cells, and a mechanical interconnect including a receiver defined within at least one of the honeycomb strips and the reinforcing strip adapted to receive at least a portion of the opposite of the honeycomb strips and reinforcing strip at an intersection thereof to connect the adjacent honeycomb strips together with the reinforcing layer, wherein the receiver receives a sufficient portion of the opposite of the honeycomb strips and reinforcing strip to cause both strips to lie within the same plane.

### Example 25

The honeycomb system of any one of Examples 24A-24C, wherein the reinforcing layer includes a base material and a reinforcing material.

### Example 26

The honeycomb system of any of one Examples 24A-24C, further comprising at least one skin attached to a surface of the honeycomb layer.

### Example 27

The honeycomb system of any one of Examples 24A-26, wherein the honeycomb system exhibits a stiffness of from 12% to 25% (or about 12% to about 25%) greater than the stiffness observed for a traditional honeycomb structure, wherein the honeycomb system and the traditional honeycomb structure have the same cell dimension and are formed from a paper having a weight of 60 gsm, when the honeycomb system and the traditional honeycomb structure are tested according to a finite element analysis using a reaction force for a displacement magnitude of 3 mm.

### Example 26

The honeycomb system of any one of Examples 24A-26, wherein the honeycomb system exhibits a stiffness of about 20% (or 20%) greater than the stiffness observed for a traditional honeycomb structure, wherein the honeycomb system and the traditional honeycomb structure have the same cell dimension and are formed from a paper having a weight of 60 gsm (or about 60 gsm), when the honeycomb system and the traditional honeycomb structure are tested according to a finite element analysis using a reaction force for a displacement magnitude of 3 mm.

It is to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

Ranges can be expressed herein as from one value (first value) to another value (second value). When such a range is expressed, the range includes in some aspects one or both of the first value and the second value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

1. A honeycomb system comprising:
a honeycomb layer extending in a weft plane, the honeycomb layer defining plural cells;
a reinforcing layer extending in a warp plane and at least partially received within the plural cells; and
a mechanical interlock adapted to connect the honeycomb layer and reinforcing layer at an intersection thereof.

2. The honeycomb system of claim 1, wherein the mechanical interlock includes a receiver formed within at least one of the honeycomb layer and the reinforcing layer, wherein a portion of the opposite layer is accepted within the receiver at an intersection of the honeycomb layer and reinforcing layer.

3. The honeycomb system of claim 2, wherein the receiver includes a slit extending partially into the at least one of the honeycomb layer and the reinforcing layer.

4. The honeycomb system of claim 2, wherein the receiver includes a mouth portion and a neck portion, wherein the mouth portion opens outwardly of the at least one of the honeycomb layer and reinforcing layer, and wherein the mouth portion is wider than the neck portion.

5. The honeycomb system of claim 4, wherein the mouth portion tapers inward as it extends inward toward neck portion.

6. The honeycomb system of claim 1, wherein the honeycomb layer includes a honeycomb strip, the honeycomb strip including plural sidewall portion portions, each sidewall portion extending at an angle to form a fold, wherein the mechanical interlock is formed in said fold.

7. The honeycomb system of claim 1, wherein the reinforcing layer includes a base material and a reinforcing material.

8. The honeycomb system of claim 7, wherein the reinforcing material is at least one of a thermoplastic and thermoset material incorporated into the reinforcing layer.

9. The honeycomb system of claim 8, wherein the reinforcing material includes a local reinforcement applied to a limited area of the base material.

10. The honeycomb system of claim 9, wherein the local reinforcement is a reinforcing fiber.

11. The honeycomb system of claim 8, wherein the reinforcing material includes a global reinforcement and a local reinforcement.

12. The honeycomb system of claim 8, wherein the base material is an aramid-based paper and the reinforcing material is a thermosetting resin.

13. The honeycomb system of claim 1, further comprising at least one skin attached to a surface of the honeycomb layer.

14. The honeycomb system of claim 1, wherein the honeycomb layer and the reinforcing layer have a uniform thickness.

15. The honeycomb system of claim 1, wherein one or both of the honeycomb layer and the reinforcing layer has a weight from about 20 gsm to about 400 gsm.

16. The honeycomb system of claim 1, wherein the reinforcing layer has a thickness from about 50 microns to about 500 microns.

17. The honeycomb system of claim 1, wherein the honeycomb system exhibits a maximum stress of at least 3000 MPa when tested according to a finite element analysis using a reaction force for a displacement magnitude of 3 mm wherein the honeycomb layer and reinforcement layer of the honeycomb system have a weight of 60 gsm.

18. The honeycomb system of claim 1, wherein the honeycomb system exhibits a stiffness of about 20% greater than the stiffness observed for a traditional honeycomb structure, wherein the honeycomb system and the traditional honeycomb structure have the same cell dimension and are formed from a paper having a weight of 60 gsm, when the honeycomb system and the traditional honeycomb structure are tested according to a finite element analysis using a reaction force for a displacement magnitude of 3 mm.

19. The honeycomb system of claim 1, wherein the honeycomb layer and the reinforcing layer are connected without an adhesive.

20. A honeycomb system comprising:
a honeycomb layer including a plurality of honeycomb strips arranged to jointly define plural cells, the plurality of honeycomb strips extending within a weft plane, wherein the honeycomb strips are adjacent one another;
a reinforcing layer including at least one reinforcing strip extending in a warp plane, the reinforcing layer overlying a portion of the honeycomb layer and extending through at least one of the plural cells; and
a mechanical interconnect including a receiver defined within at least one of the honeycomb strips and the at least one reinforcing strip adapted to receive at least a portion of the opposite of the plurality of honeycomb strips and reinforcing strip at an intersection thereof to connect the adjacent plurality of honeycomb strips together with the reinforcing layer,
wherein the receiver receives a sufficient portion of the opposite of the plurality of honeycomb strips and reinforcing strip to cause both strips to lie within the same plane.
